(19) United States
(12) Patent Application Publication
(10) Pub. No.: US 2026/0051837 A1
(43) Pub. Date: Feb. 19, 2026

(54) ROTATING MACHINE CONTROL DEVICE

(71) Applicant: Mitsubishi Electric Corporation, Tokyo (JP)

(72) Inventors: Aoto YAMAMOTO, Tokyo (JP); Toshiki SUZUKI, Tokyo (JP); Sho KATO, Tokyo (JP)

(73) Assignee: Mitsubishi Electric Corporation, Tokyo (JP)

(21) Appl. No.: 19/102,860

(22) PCT Filed: Sep. 14, 2022
(86) PCT No.: PCT/JP2022/034432

§ 371 Date: Feb. 11, 2025

(51) Int. Cl. H02P 27/08; H02M 7/5395

(52) U.S. Cl. CPC H02P 27/08; H02M 7/5395

(57) ABSTRACT

A rotating machine control device includes a voltage application unit that generates three-phase voltages; and a control unit that controls voltage generation operation of the voltage application unit in a first pulse-width modulation mode where a carrier wave frequency is asynchronous with a frequency of a voltage command or a second pulse-width modulation mode where a carrier wave frequency is synchronous with the frequency of the voltage command. On the basis of a first carrier wave used in generating a signal that controls the voltage application unit in the first pulse-width modulation mode, a second carrier wave used in generating a signal that controls the voltage application unit in the second pulse-width modulation mode, and an output voltage phase command, the control unit selects one of the first pulse-width modulation mode and the second pulse-width modulation mode as a pulse-width modulation method for controlling the voltage generation operation.

### FIELD

The present disclosure relates to a rotating machine control device that controls a rotating machine.

### BACKGROUND

To operate an alternating-current motor that is a type of rotating machine (hereinafter referred to as the rotating machine) at variable speeds, power that is supplied to the rotating machine needs to be converted to a desired voltage and frequency. For the power conversion, an inverter device is used. A typical inverter device is composed of a main circuit using semiconductor switching elements and a control device that controls the semiconductor switching elements. The inverter device obtains the desired frequency and voltage through on-off control of the semiconductor switching elements. Pulse-width modulation (PWM) control is widely used as a method of switching the semiconductor switching elements.

Pulses used in the PWM control are generated by comparing a command for voltage to be applied to the rotating machine (hereinafter referred to as the voltage command) with a carrier wave used for the pulse generation. The carrier wave to be used is, for example, a triangular wave. With an increasing carrier wave frequency, output pulses include fewer harmonics, resulting in reduced harmonic losses when applied to the rotating machine.

However, as the carrier wave frequency is increased, the semiconductor switching elements are switched more frequently, leading to heat generation associated with increased switching losses. Therefore, from the perspective of thermal design, an upper limit for the carrier wave frequency is determined.

If the carrier wave frequency is fixed regardless of the rotating machine's rotational speed, the switching frequency increases when the rotational speed of the rotating machine increases, leading to heat generation that cannot be tolerated. Accordingly, control is performed such that the carrier wave frequency is fixed when the rotational speed of the rotating machine is lower and changed in synchronization with the voltage command's frequency when the rotational speed of the rotating machine is higher. A PWM method where a carrier wave frequency does not synchronize with the frequency of the voltage command is referred to as an asynchronous PWM mode, while a PWM method where a carrier wave frequency synchronizes with the frequency of the voltage command is referred to as a synchronous PWM mode (the asynchronous PWM mode and the synchronous PWM mode may be simply referred to as the asynchronous PWM and the synchronous PWM below). For the synchronous PWM, there is a method that adopts plural carrier wave frequencies to change a count of pulses included in one cycle of the voltage command.

Switching between the PWM methods (hereinafter referred to as the PWM modes) without any consideration causes oscillations in current flowing through the rotating machine (hereinafter referred to as the current oscillations). When the current oscillations occur, the current flowing through the rotating machine, that is, the machine current may deviate from an allowable current of each semiconductor switching element, potentially causing the switching elements to break. Furthermore, depending on the current oscillations' frequency, there is a possibility of conflicting with regulations on current harmonics, in which case installation of an additional filter circuit may be required. Furthermore, mechanical vibrations and noise in the rotating machine may become problematic when the rotating machine's torque oscillates in proportion to current oscillations.

Various measures have been taken so far to address such current oscillations that occur during switching between the PWM modes. For example, Patent Literature 1 discloses a technique of switching between a variable voltage operation method using pulse-width modulation and a one-dash pulse control method near a phase angle at which centers of primary magnetic flux trajectories in a stationary reference frame of the rotating machine deviate the least from each other.

### CITATION LIST

### Patent Literature

Patent Literature 1: Japanese Patent No. 2911734

### SUMMARY OF INVENTION

### Problem to be Solved by the Invention

However, the technique described in Patent Literature 1, which effects switching between PWM modes at a prespecified phase, has a problem in that the technique cannot be applied to switching between the asynchronous PWM, which operates without synchronization with voltage phase, and the synchronous PWM, which operates in synchronization with the voltage phase.

The present disclosure has been made in view of the above, and an object of the present disclosure is to obtain a rotating machine control device capable of restraining current oscillations when switching the PWM mode used to control generation operation of voltage to be applied to a rotating machine between the asynchronous PWM and the synchronous PWM.

### Means to Solve the Problem

In order to solve the above-described problem and achieve the object, a rotating machine control device according to the present disclosure includes: a voltage application unit to generate three-phase voltages to be applied to a rotating machine; and a control unit to control voltage generation operation of the voltage application unit in a first pulse-width modulation mode or a second pulse-width modulation mode, the first pulse-width modulation mode being a pulse-width modulation method where a carrier wave frequency is asynchronous with a frequency of a voltage command, the second pulse-width modulation mode being a pulse-width modulation method where a carrier wave frequency is synchronous with a frequency of a voltage command. On a basis of a first carrier wave used in generating a signal that controls the voltage application unit in the first pulse-width modulation mode, a second carrier wave used in generating a signal that controls the voltage application unit in the second pulse-width modulation mode, and an output voltage phase command commanding a phase of each of voltages to be output to the rotating machine, the control unit selects one of the first pulse-width modulation mode and the second pulse-width modulation mode as a pulse-width modulation method to be used for controlling the voltage generation operation.

### Effect of the Invention

The rotating machine control device according to the present disclosure has an effect of restraining current oscillations when switching the PWM mode used to control the generation operation of the voltage to be applied to the rotating machine between the asynchronous PWM and the synchronous PWM.

### BRIEF DESCRIPTION OF DRAWINGS

FIG. 1 is a diagram illustrating an exemplary configuration of a rotating machine control device according to a first embodiment.

FIG. 2 is a diagram illustrating an exemplary configuration of a timing generator included in the rotating machine control device according to the first embodiment.

FIG. 3 is a diagram illustrating an exemplary configuration of a voltage application unit included in the rotating machine control device according to the first embodiment.

FIG. 4 is a diagram illustrating an example of a storage unit that stores comparison values that the timing generator according to the first embodiment uses in a process of generating a timing signal.

FIG. 5 is a diagram illustrating another example of the storage unit that stores the comparison values that the timing generator according to the first embodiment uses in the process of generating the timing signal.

FIG. 6 is a diagram illustrating an exemplary configuration of a timing generator included in a rotating machine control device according to a second embodiment.

FIG. 7 is a diagram illustrating an example of a storage unit that stores comparison values and a delayed phase that the timing generator according to the second embodiment uses in a process of generating a timing signal.

FIG. 8 is a diagram illustrating another example of the storage unit that stores the comparison values and the delayed phase that the timing generator according to the second embodiment uses in the process of generating the timing signal.

FIG. 9 is a diagram illustrating a variation of the storage unit illustrated in FIG. 7.

FIG. 10 is a diagram illustrating a variation of the storage unit illustrated in FIG. 8.

FIG. 11 is a diagram illustrating a first example of current oscillations that occur during switching between PWM modes.

FIG. 12 is a diagram illustrating a second example of current oscillations that occur during switching between the PWM modes.

FIG. 13 is a diagram illustrating examples of carrier waves used respectively in two synchronous PWM modes between which switching is performed.

FIG. 14 is a diagram illustrating a magnetic flux evaluation function generated by synchronous carrier waves #1 and #2 illustrated in FIG. 13.

FIG. 15 is a diagram illustrating examples of carrier waves used respectively in two PWM modes when switching is performed from an asynchronous one of the PWM modes to a synchronous one.

FIG. 16 is a diagram illustrating a magnetic flux evaluation function generated by the asynchronous and synchronous carrier waves illustrated in FIG. 15.

### DESCRIPTION OF EMBODIMENTS

With reference to the drawings, a detailed description is hereinafter provided of rotating machine control devices according to embodiments of the present disclosure.

### First Embodiment

Before details of a rotating machine control device according to the present embodiment are explained, a description is first provided of current oscillations that become problematic during switching between PWM modes.

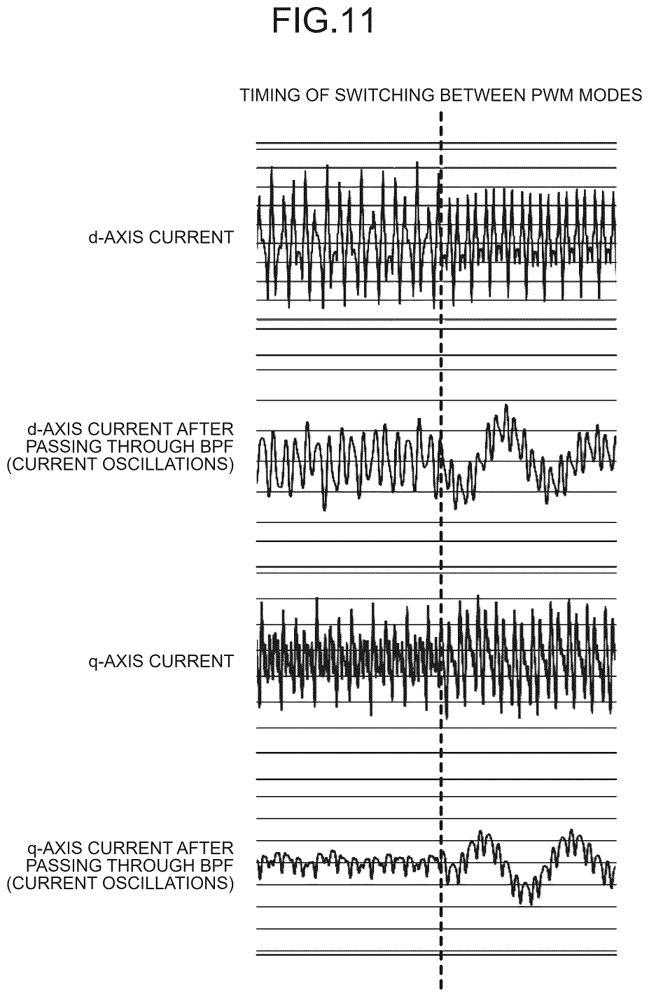

FIG. 11 is a diagram illustrating a first example of current oscillations that occur during switching between PWM modes, specifically the example of current oscillations that occur when a conventional rotating machine control device, which is a comparative example, switches between the PWM modes. FIG. 11 illustrates currents expressed in a rotating reference frame (by dq transformation) on the basis of a magnetic pole position of a rotating machine after three-phase to two-phase transformation of three-phase alternating currents of the rotating machine. The current oscillations that occur during the switching between the PWM modes can be extracted by passing the d-axis and q-axis machine currents through a band pass filter (BPF) centered around a frequency of a voltage command. A first row from the top in FIG. 11 illustrates the d-axis current, namely the d-axis machine current, and a second row illustrates oscillations in the d-axis current (the d-axis current after passing through the BPF). A third row illustrates the q-axis current, namely the q-axis machine current, and a fourth row illustrates oscillations in the q-axis current (the q-axis current after passing through the BPF). A dotted vertical midline indicates a timing of the switching between the PWM modes.

A description is provided of a factor that contributes to the occurrence of the current oscillations illustrated in FIG. 11. When the rotating machine, which is to be controlled, is an interior permanent magnet synchronous motor (IPMSM), voltage equations in the rotating reference frame are represented by Formula (1).

$$\begin{matrix}Formula 1 & \\ \{ \begin{matrix}{v}_{d} = {Ri}_{d} ( t ) + \frac{d {φ}_{d}}{dt} - {ωφ}_{q} \\ {v}_{q} = {Ri}_{q} ( t ) + \frac{d {φ}_{q}}{dt} + {ωφ}_{d}\end{matrix} & ( 1 )\end{matrix}$$

$$[ \begin{matrix}{φ}_{d} = {φ}_{m} + {L}_{d} {i}_{d} ( t ) \\ {φ}_{q} = {L}_{q} {i}_{q} ( t )\end{matrix} ]$$

In Formula (1), v_{d} and v_{q} respectively represent voltages applied to the d-axis and the q-axis of the IPMSM, and i_{d} and i_{q} respectively represent currents flowing along the d-axis and the q-axis of the IPMSM. L_{d} and L_{q} respectively represent d-axis and q-axis inductances of the IPMSM, and φ_{d} and φ_{q} respectively represent d-axis and q-axis magnetic fluxes of the IPMSM. φm represents magnet flux, R represents winding resistance, and ω represents an angular frequency of a fundamental wave of voltage applied to the IPMSM. d/dt represents a differentiation operation. i_{d} and i_{q} are time functions. Time is represented by t.

Suppose Formula (1) represents the voltage equations in a transient state immediately after switching between the PWM modes, while Formula (2) below represents voltage equations in a steady state. Voltage equations for differences are represented by Formula (3) below.

$$\begin{matrix}Formula 2 & \\ \{ \begin{matrix}{v}_{d} = {Ri}_{d}^{′} ( t ) + \frac{d {φ}_{d}^{′}}{dt} - {ωφ}_{q}^{′} \\ {v}_{q} = {Ri}_{q}^{′} ( t ) + \frac{d {φ}_{q}^{′}}{dt} + {ωφ}_{d}^{′}\end{matrix} & ( 2 )\end{matrix}$$

$$[ \begin{matrix}{φ}_{d}^{′} = {φ}_{m} + {L}_{d} {i}_{d}^{′} ( t ) \\ {φ}_{q}^{′} = {L}_{q} {i}_{q}^{′} ( t )\end{matrix} ]$$

$$\begin{matrix}Formula 3 & \\ \{ \begin{matrix}0 = R Δ {i}_{d} ( t ) + \frac{d {φ}_{d}}{dt} - {ωΔφ}_{q} \\ 0 = R Δ {i}_{q} ( t ) + \frac{d {φ}_{q}}{dt} + {ωΔφ}_{d}\end{matrix} & ( 3 )\end{matrix}$$

$$[ \begin{matrix}{Δφ}_{d} = {φ}_{d} - {φ}_{d}^{′} \\ {Δφ}_{q} = {φ}_{q} - {φ}_{q}^{′}\end{matrix} ]$$

In Formulas (2) and (3), the d-axis and q-axis currents in the steady state are represented by i_{d}′ and i_{q}′, and the d-axis and q-axis magnetic fluxes in the steady state are represented by φ_{d}′ and φ_{q}′. In Formula (3), each term expressing a difference between Formula (1) and Formula (2) is denoted with Δ, with the differences in the d-axis and q-axis currents represented by Δi_{d} and Δi_{q} and the differences in the d-axis and q-axis magnetic fluxes represented by Δφ_{d} and Δφ_{q}. The voltages applied to the IPMSM are assumed to remain unchanged between the transient state and the steady state; therefore, the difference in each voltage between Formulas (1) and (2) is 0. i_{d}′ and i_{q}′ in Formula (2) and Δi_{d} and Δi_{q} in Formula (3) are also time functions.

Using the Laplace transform to solve Formula (3) for the currents as the time functions, Formula (4) can be derived. In Formula (4), e is Napier's constant, which is used to represent an exponential function.

$$\begin{matrix}Formula 4 & \\ Δ {i}_{d} ( t ) = {e}^{- \frac{R ( {L}_{d} + {L}_{q} )}{2 {L}_{d} {L}_{q}}} \cdot \frac{1}{{L}_{d}} \sqrt{{Δφ}_{d}^{2} + {Δφ}_{q}^{2}} \cdot sin ( ω t + θ ) & ( 4 )\end{matrix}$$

$$Δ {i}_{q} ( t ) = {e}^{- \frac{R ( {L}_{d} + {L}_{q} )}{2 {L}_{d} {L}_{q}}} \cdot \frac{1}{{L}_{q}} \sqrt{{Δφ}_{d}^{2} + {Δφ}_{q}^{2}} \cdot cos ( ω t + θ )$$

$$θ = {tan}^{- 1} ( \frac{{Δφ}_{d}}{{Δφ}_{q}} ) {Δφ}_{d} = {φ}_{d} - {φ}_{d}^{′} {Δφ}_{q} = {q}_{d} - {φ}_{q}^{′}$$

According to Formula (4), the currents Δi_{d} and Δi_{q} during the switching between the PWM modes are sine and cosine waves proportional to the differences in the motor's magnetic fluxes, Δφ_{d} and Δφ_{q}, along the axes before and after the switching. When combined with exponential terms, the currents Δi_{d} and Δi_{q} become damped oscillations. Furthermore, the d-axis and q-axis currents are inversely proportional to the motor's d-axis and q-axis inductances L_{d} and L_{q}. Among the variables included in Formula (4), only the differences in the motor's magnetic fluxes, Δφ_{d}, and Δφ_{q}, can be manipulated through control without modifying the motor. Therefore, if switching between the PWM modes is performed to reduce the differences Δφ_{d} and Δφ_{q} in the motor's magnetic fluxes, current oscillations can be restrained. The current oscillations' frequency is the angular frequency ω of an inverter, and the current oscillations' phase is determined by performing an arctangent operation on the differences Δφ_{d} and Δφ_{q} in the motor's magnetic fluxes.

A method for computing motor fluxes is described here. The flux linkages (motor fluxes) φᵤ, φᵥ, and φ_{w} of u, v, and w phases can be computed from phase voltages vᵤ, vᵥ, and v_{w} of the three phases, phase currents iᵤ, iᵥ, and i_{w} of the three phases, and the winding resistance R. Equations for computing the motor fluxes are represented by Formula (5).

$$\begin{matrix}Formula 5 & \\ {φ}_{u} = \int {v}_{u} - {Ri}_{u} dt & ( 5 )\end{matrix}$$

$${φ}_{v} = \int {v}_{v} - {Ri}_{v} dt$$

$${φ}_{w} = \int {v}_{w} - {Ri}_{w} dt$$

When the rotating machine's rotational speed is higher than or equal to a medium speed, the second term on each right side of Formula (5) is smaller than the first term on each right side and thus can be ignored. Therefore, the computation of the motor fluxes only needs to use integrals of the voltages of the phases. Since voltages applied from the inverter to the motor are each the product of a corresponding PWM pulse applied to a gate of a semiconductor switching element in the inverter and half a supply voltage, the integral of the voltage for each phase of the motor and an integral of the corresponding PWM pulses applied to the gate have similar waveforms. Therefore, quantities equivalent to the motor fluxes can be computed from the PWM pulses applied to the inverter.

To express the motor fluxes in the rotating reference frame, three-phase to two-phase transformation shown in Formula (6) below is performed. Furthermore, rotating frame transformation based on the magnetic pole position θₘ of the motor is performed, as shown in Formula (7).

$$\begin{matrix}Formula 6 & \\ [ \begin{matrix}{φ}_{α} \\ {φ}_{β}\end{matrix} ] = \sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{φ}_{u} \\ {φ}_{v} \\ {φ}_{w}\end{matrix} ] & ( 6 )\end{matrix}$$

$$\begin{matrix}Formula 7 & \\ [ \begin{matrix}{φ}_{d} \\ {φ}_{q}\end{matrix} ] = [ [ \begin{matrix}cos {θ}_{m} & sin {θ}_{m} \\ - sin {θ}_{m} & cos {θ}_{m}\end{matrix} ] [ [ \begin{matrix}{φ}_{α} \\ {φ}_{β}\end{matrix} ] & ( 7 )\end{matrix}$$

According to Formula (4) above, reducing the differences Δφ_{d} and Δφ_{q} in the motor's magnetic fluxes before and after the switching between the PWM modes can restrain the current oscillations during the switching between the PWM modes. The term for the differences in the motor's magnetic fluxes in Formula (4) is defined as a magnetic flux evaluation function E_{f}, as shown in Formula (8) below.

$$\begin{matrix}Formula 8 & \\ {E}_{f} = \sqrt{{Δφ}_{d}^{2} + {Δφ}_{q}^{2}} & ( 8 )\end{matrix}$$

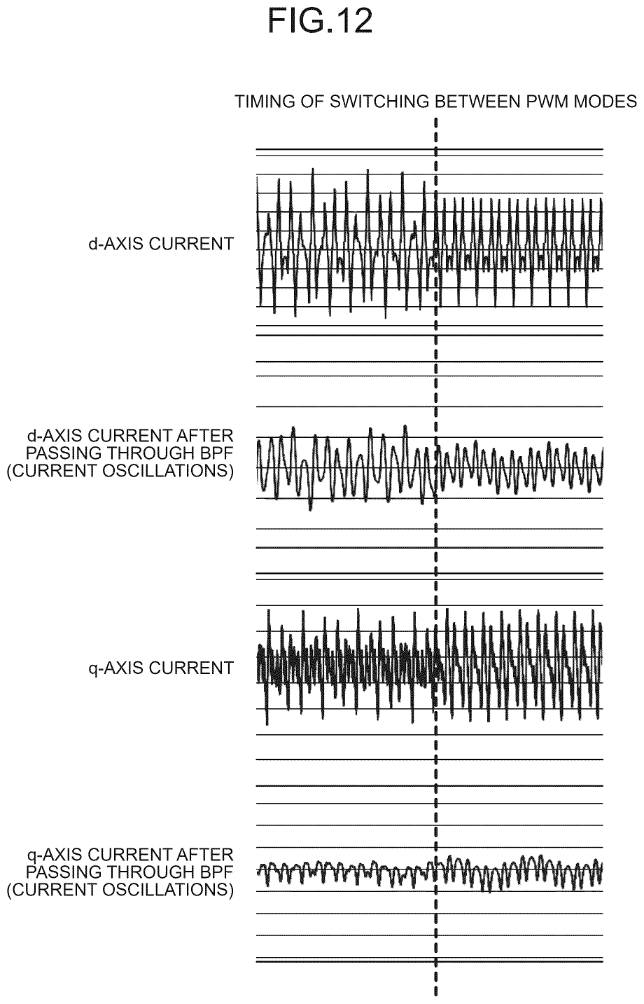

FIG. 12 illustrates motor currents during switching between the PWM modes when the magnetic flux evaluation function E_{f} is made smaller. FIG. 12 is a diagram illustrating the second example of current oscillations during the switching between the PWM modes. As in FIG. 11, a first row from the top illustrates the d-axis current, a second row illustrates oscillations in the d-axis current (the d-axis current after passing through the BPF), a third row illustrates the q-axis current, and a fourth row illustrates oscillations in the q-axis current (the q-axis current after passing through the BPF). A dotted vertical midline indicates a timing of the switching between the PWM modes. The current oscillations illustrated in FIG. 12 correspond to an example of current oscillations resulting from the application of the first embodiment. As illustrated in FIG. 12, making the magnetic flux evaluation function E_{f} defined by Formula (8) smaller can restrain current oscillations during switching between the PWM modes compared to the case illustrated in FIG. 11.

Next, a description is provided of characteristics of a magnetic flux evaluation function associated with switching between synchronous PWM modes and a magnetic flux evaluation function associated with switching from an asynchronous PWM mode to a synchronous PWM mode.

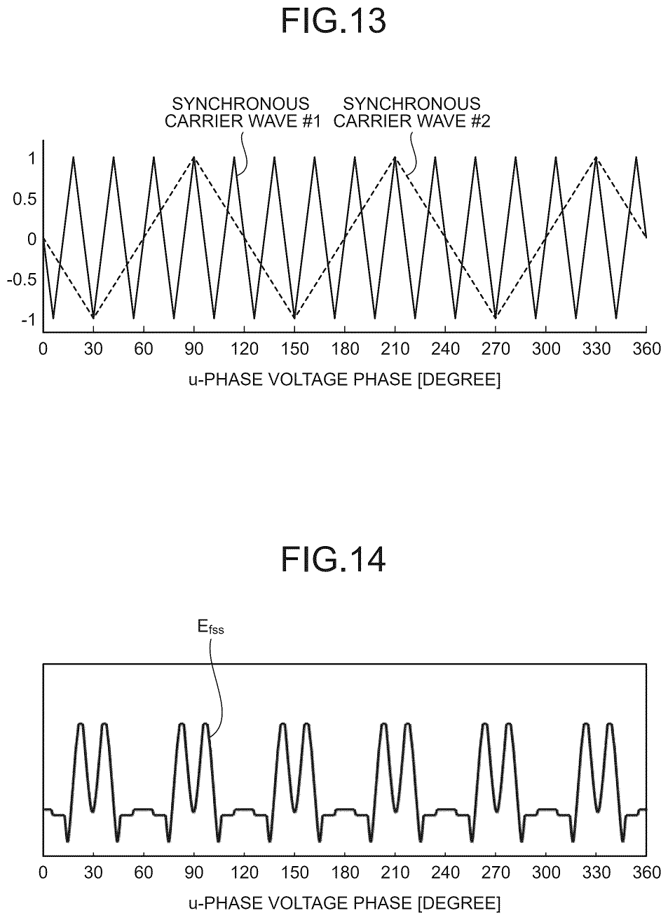

FIG. 13 is a diagram illustrating examples of carrier waves used respectively in the two synchronous PWM modes between which the switching is performed. The carrier waves are referred to as synchronous carrier waves #1 and #2. FIG. 14 is a diagram illustrating the magnetic flux evaluation function E_{fss} generated by synchronous carrier waves #1 and #2 illustrated in FIG. 13.

In a synchronous PWM, a carrier wave synchronizes with a phase of the u-phase voltage (hereinafter referred to simply as the voltage phase); therefore, the voltage applied to the IPMSM synchronizes with the voltage phase, and the motor flux, which is expressed by the integral of the voltage applied to the IPMSM, also synchronizes with the voltage phase. Since the motor flux synchronizes with the voltage phase before and after the switching between the PWM modes, the magnetic flux evaluation function E_{fss}, as a result, synchronizes with the voltage phase, as illustrated in FIG. 14. The magnetic flux evaluation function E_{fss}, which is associated with the switching between the synchronous PWM modes that respectively use synchronous carrier waves #1 and #2 illustrated in FIG. 13, has a waveform that repeats every 60 degrees as illustrated in FIG. 14. Therefore, for switching between the synchronous PWMs, a phase at which the magnetic flux evaluation function E_{fss} is minimized can be easily precomputed from a relationship between the respective carrier waves of the synchronous PWMs.

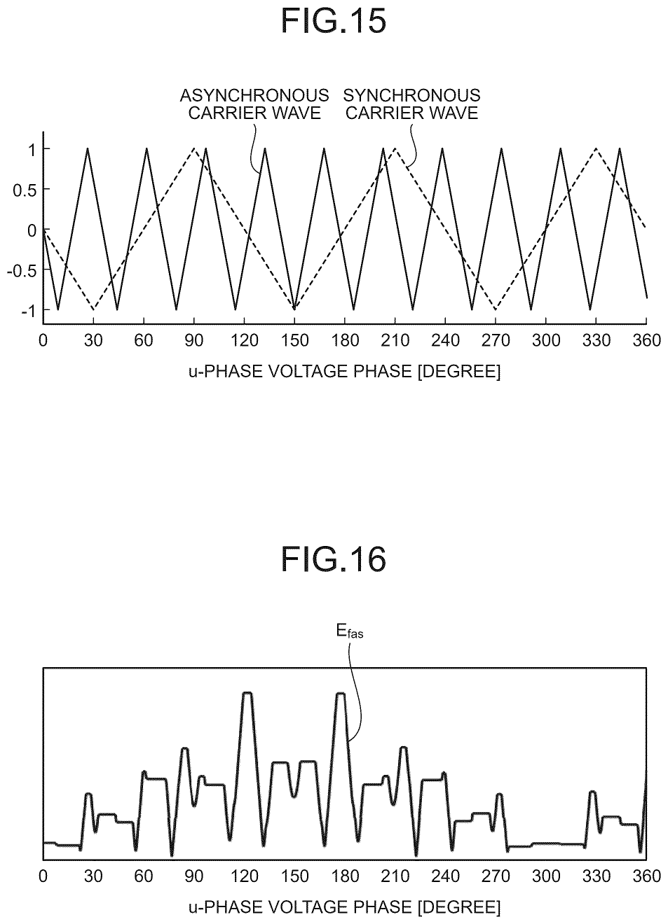

FIG. 15 is a diagram illustrating examples of carrier waves used respectively in the two PWM modes (the asynchronous and synchronous PWMs) when the switching is performed from the asynchronous PWM to the synchronous PWM. The carrier wave used in the asynchronous PWM refers to an asynchronous carrier wave, and the carrier wave used in the synchronous PWM refers to a synchronous carrier wave. FIG. 16 is a diagram illustrating the magnetic flux evaluation function E_{fss} generated by the asynchronous and synchronous carrier waves illustrated in FIG. 15.

In an asynchronous PWM, a carrier wave (corresponding to the asynchronous carrier wave illustrated in FIG. 15) does not synchronize with the voltage phase; therefore, the voltage applied to the IPMSM does not synchronize with the voltage phase, and the motor flux, which is expressed by the integral of the voltage applied to the IPMSM, also does not synchronize with the voltage phase. Therefore, when computed on the basis of the motor flux obtained when the IPMSM is controlled in the synchronous PWM and the motor flux obtained when the IPMSM is controlled in the asynchronous PWM, the magnetic flux evaluation function E_{fss} does not synchronize with the voltage phase. Furthermore, a waveform that repeats every 60 degrees, as observed with the switching between the synchronous PWM modes, is not seen. Since the carrier wave of the asynchronous PWM does not synchronize with the voltage phase, the magnetic flux evaluation function E_{fss} changes its form over one cycle of the voltage phase, depending on a phase of the carrier wave of the asynchronous PWM. Therefore, for switching from the asynchronous PWM mode to the synchronous PWM mode, identifying a phase at which the magnetic flux evaluation function E_{fss} is minimized is not possible. Since a difference in the magnetic flux remains the same even for switching from the synchronous PWM mode to the asynchronous PWM mode, identifying a phase at which the magnetic flux evaluation function is minimized is not possible. In other words, for the switching between the asynchronous PWM and the synchronous PWM, identifying the phase at which the magnetic flux evaluation function is minimized is not possible.

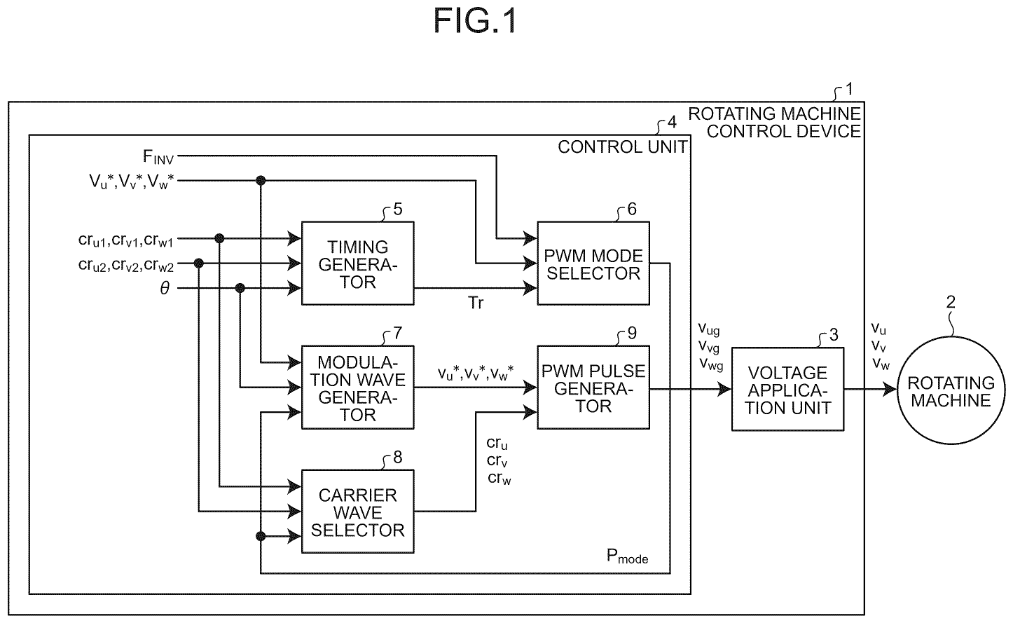

Next, a description is provided of the rotating machine control device according to the first embodiment. FIG. 1 is a diagram illustrating an exemplary configuration of the rotating machine control device 1 according to the first embodiment.

The rotating machine control device 1 includes a voltage application unit 3 and a control unit 4. The voltage application unit 3 is connected to a rotating machine 2 and generates three-phase voltages Vᵤ, Vᵥ, and V_{w} to be applied to the rotating machine 2. The control unit 4 is connected to the voltage application unit 3 and generates PWM pulses V_{ug}, V_{vg}, and V_{wg} as PWM signals to control voltage generation operation of the voltage application unit 3 in a first PWM mode or a second PWM mode. In the present embodiment, the first PWM mode is described as an asynchronous PWM, and the second PWM mode is described as a synchronous PWM.

The control unit 4 includes a timing generator 5, a PWM mode selector 6, a modulation wave generator 7, a carrier wave selector 8, and a PWM pulse generator 9.

First carrier waves Crᵤ₁, crᵥ₁, and Cr_{w1}, second carrier waves crᵤ₂, crᵥ₂, and cr_{w2}, and an output voltage phase command θ are input to the timing generator 5. The output voltage phase command θ indicates a command value for a phase of each of the three-phase voltages Vᵤ, Vᵥ, and V_{w} to be output from the voltage application unit 3 to the rotating machine 2. The timing generator 5 determines whether or not a timing qualifies for switching between the PWM modes on the basis of the first carrier wave crᵤ₁, crᵥ₁, or cr_{w1}, the second carrier wave crᵤ₂, crᵥ₂, or cr_{w2}, and the output voltage phase command θ. Upon determining that the timing qualifies for switching between the PWM modes, the timing generator 5 generates a timing signal Tr indicating that the timing qualifies for switching between the PWM modes.

A fundamental frequency F_{INV} of the voltage output from the voltage application unit 3, voltage commands Va′, Vᵥ⁺, and V_{w}⁺ used for controlling the rotating machine 2, and the timing signal Tr output from the timing generator 5 are input to the PWM mode selector 6. The PWM mode selector 6 generates a PWM mode selection signal P_{mode} based on the fundamental frequency F_{INV}, the voltage commands Vᵤ⁺, Vᵥ⁺, and V_{w}⁺, and the timing signal Tr.

The voltage commands Vᵤ⁺, Vᵥ⁺, and V_{w}⁺, the output voltage phase command θ, and the PWM mode selection signal P_{mode} are input to the modulation wave generator 7. The modulation wave generator 7 generates modulation waves vᵤ⁺, Vᵥ⁺, and v_{w}⁺ based on the voltage commands Vᵤ⁺, Vᵥ⁺, and V_{w}⁺, the output voltage phase command θ, and the PWM mode selection signal P_{mode}.

The first carrier waves crᵤ₁, crᵥ₁, and cr_{w1}, the second carrier waves crᵤ₂, crᵤ₂, and crᵤ₂, and the PWM mode selection signal P_{mode} are input to the carrier wave selector 8. On the basis of the PWM mode selection signal P_{mode}, the carrier wave selector 8 selects the first carrier waves crᵤ₁, crᵥ₁, and cr_{w1} or the second carrier waves crᵤ₂, crᵥ₂, and cr_{w2} to output as the carrier waves crᵤ, crᵥ, and cr_{w}.

The modulation waves vᵤ⁺, vᵥ⁺, and v_{w}⁺ and the carrier waves crᵤ, crᵥ, and cr_{w} are input to the PWM pulse generator 9. On the basis of the modulation waves vᵤ⁺, vᵥ⁺, and v_{w}⁺ and the carrier waves crᵤ, crᵥ, and cr_{w}, the PWM pulse generator 9 generates the PWM pulses V_{ug}, V_{vg}, and V_{wg}, which serve as the PWM signals for controlling the voltage application unit 3. In the following description, PWM pulses that the PWM pulse generator 9 generates when operating in the asynchronous PWM may be referred to as the asynchronous PWM pulses, and PWM pulses that the PWM pulse generator 9 generates when operating in the synchronous PWM may be referred to as the synchronous PWM pulses.

The PWM pulses V_{ug}, V_{vg}, and V_{wg} generated by the PWM pulse generator 9 are input to the voltage application unit 3. On the basis of the PWM pulses V_{ug}, V_{vg}, and V_{wg}, the voltage application unit 3 generates the three-phase voltages Vᵤ, Vᵥ, and V_{w} to be applied to the rotating machine 2.

The rotating machine 2 is driven by the three-phase voltages Vᵤ, Vᵥ, and V_{w} output from the voltage application unit 3. The rotating machine 2 may be the aforementioned IPMSM, an induction motor (IM), or a synchronous reluctance motor (SynRM).

The first carrier waves crᵤ₁, crᵥ₁, and cr_{w1} input to the timing generator 5 and the carrier wave selector 8 are the carrier waves corresponding to the first PWM mode and are asynchronous carrier waves that do not synchronize with the output voltage phase command θ. The second carrier waves crᵤ₂, crᵥ₂, and cr_{w2} are the carrier waves corresponding to the second PWM mode and are synchronous carrier waves that synchronize with the output voltage phase command θ. The first carrier waves crᵤ₁, crᵥ₁, and cr_{w1} may be carrier waves that are in phase or carrier waves that are out of phase among the three phases. Similarly, the second carrier waves crᵤ₂, crᵥ₂, and cr_{w2} may be carrier waves that are in phase or carrier waves that are out of phase among the three phases. The first carrier waves crᵤ₁, crᵥ₁, and cr_{w1} and the second carrier waves crᵤ₂, crᵥ₂, and cr_{w2} are unitless signals, and their respective values change between −1 and +1.

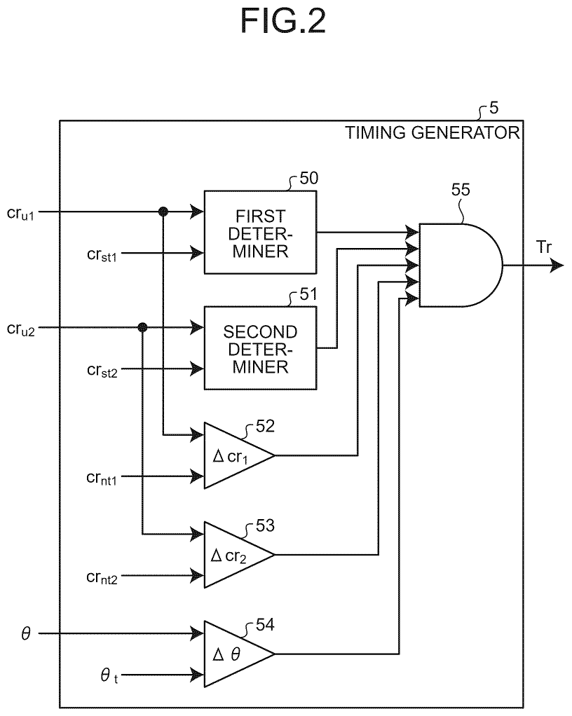

FIG. 2 is a diagram illustrating an exemplary configuration of the timing generator 5 included in the rotating machine control device 1 according to the first embodiment.

The timing generator 5 includes a first determiner 50, a second determiner 51, operators 52 to 54, and a logical conjunction operator 55.

The first carrier wave crᵤ and a computed result Crₛₜ₁, which is a precomputed sign of slope of the first carrier wave crᵤ₁ and is retained in a memory, are input to the first determiner 50. The computed result crₛₜ₁ retained in the memory is a comparison value. The first determiner 50 compares a sign of slope of the input first carrier wave crᵤ₁ to the comparison value crₛₜ₁. The first determiner 50 outputs a value indicating true when both match and a value indicating false when both do not match. Specifically, the first determiner 50 outputs “1” when the sign of the slope of the first carrier wave crᵤ₁ and the comparison value crₛₜ₁ match and “0” when the sign of the slope of the first carrier wave crᵤ and the comparison value crₛₜ₁ do not match.

The second carrier wave crᵤ₂ and a computed result crₛₜ₂, which is a precomputed sign of slope of the second carrier wave crᵤ₂ and is retained in the memory, are input to the second determiner 51. The computed result crₛₜ₂ retained in the memory is a comparison value. The second determiner 51 compares a sign of slope of the input second carrier wave crᵤ₂ to the comparison value crₛₜ₂. The second determiner 51 outputs a value indicating true when both match and a value indicating false when both do not match. Specifically, the second determiner 51 outputs “1” when the sign of the slope of the second carrier wave crᵤ₂ and the comparison value crₛₜ₂ match and “0” when the sign of the slope of the second carrier wave crᵤ₂ and the comparison value crₛₜ₂ do not match.

The first carrier wave crᵤ and a result crₙₜ₁ of precomputing the first carrier wave crᵤ₁, which is retained in the memory, are input to the operator 52. The computed result crₙₜ₁ retained in the memory is a comparison value. The operator 52 computes an instantaneous carrier wave value difference Δcr₁ between an instantaneous value of the input first carrier wave crᵤ and the comparison value crₙₜ₁. The operator 52 outputs a value indicating true when the instantaneous carrier wave value difference Δcr₁ is 0 or within an acceptable range of deviation and a value indicating false when the instantaneous carrier wave value difference Δcr₁ is not within the acceptable range of deviation. Specifically, the operator 52 outputs “1” as the value indicating true when the instantaneous carrier wave value difference Δcr₁ is less than a predetermined threshold and “0” as the value indicating false when the instantaneous carrier wave value difference Δcr₁ is greater than or equal to the threshold.

The second carrier wave crus and a result crₙₜ₂ of precomputing the second carrier wave crᵤ₂, which is retained in the memory, are input to the operator 53. The computed result crₙₜ₂ retained in the memory is a comparison value. The operator 53 computes an instantaneous carrier wave value difference Δcr₂ between an instantaneous value of the input second carrier wave crᵤ₂ and the comparison value crₙₜ₂. The operator 53 outputs a value indicating true when the instantaneous carrier wave value difference Δcr₂ is 0 or within an acceptable range of deviation and a value indicating false when the instantaneous carrier wave value difference Δcr₂ is not within the acceptable range of deviation. Specifically, the operator 53 outputs “1” as the value indicating true when the instantaneous carrier wave value difference Δcr₂ is less than a predetermined threshold and “0” as the value indicating false when the instantaneous carrier wave value difference Δcr₂ is greater than or equal to the threshold.

The output voltage phase command θ and a result θₜ of precomputing the output voltage phase command θ, which is retained in the memory, are input to the operator 54. The computed result θₜ retained in the memory is a comparison value. The operator 54 computes a phase difference Δθ between the input output voltage phase command θ and the comparison value θₜ. The operator 54 outputs a value indicating true when the phase difference Δθ is 0 or within an acceptable range of deviation and a value indicating false when the phase difference Δθ is not within the acceptable range of deviation. Specifically, the operator 54 outputs “1” as the value indicating true when the phase difference Δθ is less than a predetermined threshold and “0” as the value indicating false when the phase difference Δθ is greater than or equal to the threshold.

The signals output respectively from the first determiner 50, the second determiner 51, and the operators 52 to 54 are input to the logical conjunction operator 55. The logical conjunction operator 55 outputs a value indicating true as the timing signal Tr when every input signal is the value indicating true, that is, “1” and a value indicating false as the timing signal Tr when the input signals include any values indicating false. Specifically, the logical conjunction operator 55 outputs “1” as the timing signal Tr when every input signal is the value indicating true and “0” as the timing signal Tr when the input signals include any values indicating false.

The aforementioned precomputed comparison values, namely crₛₜ₁, crₛₜ₂, crₙₜ₁, crₙₜ₂, and θₜ, may be retained within the timing generator 5 or in an external storage means.

In the example described in the present embodiment, the timing generator 5 determines, on the basis of the first and second carrier waves crᵤ₁ and crᵤ₂ for the u phase and the output voltage phase command θ, whether or not the timing qualifies for switching between the PWM modes and changes the state of the timing signal Tr upon determining that the timing qualifies for switching between the PWM modes. However, the timing generator 5 may determine the timing for switching between the PWM modes on the basis of the first and second carrier waves for the v phase and the output voltage phase command θ or on the basis of the first and second carrier waves for the w phase and the output voltage phase command θ.

On the basis of the fundamental frequency F_{INV} Of the voltage output from the voltage application unit 3 and the voltage commands Vᵤ⁺, Vᵥ⁺, and V_{w}⁺ used for controlling the rotating machine 2, the PWM mode selector 6 generates the PWM mode selection signal P_{mode} selecting the first PWM mode or the second PWM mode and outputs the PWM mode selection signal P_{mode} to the modulation wave generator 7 and the carrier wave selector 8. The PWM mode selector 6 switches a value of the PWM mode selection signal P_{mode} at a timing when the timing signal Tr input from the timing generator 5 logically reverses from false to true.

The modulation waves vᵤ⁺, vᵥ⁺, and v_{w}⁺ generated by the modulation wave generator 7 are three-phase sine waves for the u phase, the v phase, and the w phase, respectively. A phase difference of 120 degrees is established between the modulation waves vᵤ⁺, vᵥ⁺, and v_{w}⁺. Amplitudes of the modulation waves vᵤ⁺, vᵥ⁺, and v_{w}⁺ are determined by the voltage commands Vᵤ⁺, Vᵥ⁺, and V_{w}⁺ input to the modulation wave generator 7. Each of the voltage commands Vᵤ⁺, Vᵥ⁺, and V_{w}⁺ has a magnitude of 0 to 4/π, with a maximum amplitude of a fundamental wave obtained from Fourier series expansion of a square wave being 4/π.

Each of the modulation waves vᵤ⁺, vᵥ⁺, and v_{w}⁺ may include a superimposed third harmonic with a frequency three times that of the modulation wave to improve a utilization rate of the voltage output from the voltage application unit 3. When the rotating machine 2 is driven with the magnitudes of the voltage commands Vᵤ⁺, Vᵥ⁺, and V_{w}⁺ each exceeding 1, gains may be multiplied to correct relationships between fundamental voltages determined from the Fourier series expansion of the voltages vᵤ, v_{w}, and v_{w} applied to the rotating machine 2 and the corresponding voltage commands Vᵤ⁺, Vᵥ⁺, and V_{w}⁺. The aforementioned third harmonics and correction gains may differ between modulation waves corresponding to the asynchronous PWM pulses and modulation waves corresponding to the synchronous PWM pulses. For this reason, the modulation wave generator 7 switches between the modulation waves corresponding to the asynchronous PWM pulses and the modulation waves corresponding to the synchronous PWM pulses on the basis of the PWM mode selection signal P_{mode} to output as the modulation waves vᵤ⁺, vᵥ⁺, and v_{w}⁺.

On the basis of the PWM mode selection signal P_{mode}, the carrier wave selector 8 selects the first carrier waves crᵤ₁, crᵥ₁, and cr_{w1}, which correspond to the asynchronous PWM pulses, or the second carrier waves crᵤ₂, crᵥ₂, and cr_{w2}, which correspond to the synchronous PWM pulses, to output as the carrier waves crᵤ, crᵥ, and cr_{w}.

The PWM pulse generator 9 compares magnitudes of the modulation waves vᵤ⁺, vᵥ⁺, and v_{w}⁺ input from the modulation wave generator 7 and the carrier waves crᵤ, crᵥ, and cr_{w} input from the carrier wave selector 8 separately for the u phase, the v phase, and the w phase. For the u phase, the PWM pulse V_{ug} output to the voltage application unit 3 is true, that is, “1” when the modulation wave vᵤ⁺ is greater than the carrier wave crᵤ and false, that is, “0” when the modulation wave vᵤ⁺ is less than or equal to the carrier wave crᵤ. Similarly, for the v phase and the w phase, magnitudes of the modulation and carrier waves for each phase are compared, and a value (“1” or “0”) based on a comparison result is output as the PWM pulse v_{vg} or v_{wg} to the voltage application unit 3.

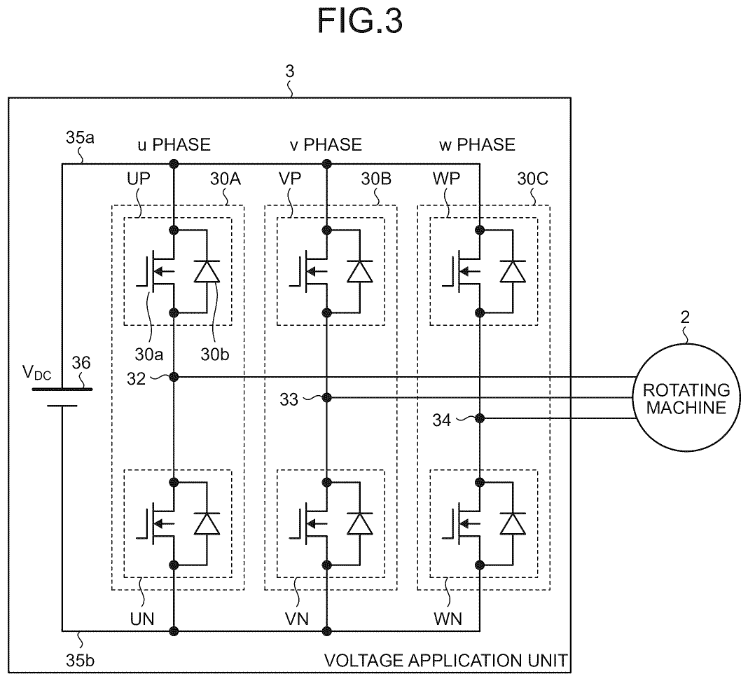

The voltage application unit 3 has, for example, a configuration illustrated in FIG. 3. FIG. 3 is a diagram illustrating the exemplary configuration of the voltage application unit 3 included in the rotating machine control device 1 according to the first embodiment, specifically illustrating the exemplary circuit configuration when the voltage application unit 3 is a three-phase PWM inverter.

The voltage application unit 3 includes a leg 30A where an upper-arm semiconductor element UP and a lower-arm semiconductor element UN are connected in series, a leg 30B where an upper-arm semiconductor element VP and a lower-arm semiconductor element VN are connected in series, and a leg 30C where an upper-arm semiconductor element WP and a lower-arm semiconductor element WN are connected in series.

The legs 30A to 30C are connected in parallel, and a bus voltage is applied to the legs 30A to 30C through direct-current buses 35a and 35b. The voltage application unit 3 converts direct-current power supplied from a power source 36 to the legs 30A to 30C through the direct-current buses 35a and 35b into alternating-current power and supplies the converted alternating-current power to the rotating machine 2, thus driving the rotating machine 2.

In FIG. 3, the semiconductor elements UP, UN, VP, VN, WP, and WN are exemplified by metal-oxide-semiconductor field-effect transistors (MOSFETs). The semiconductor element UP includes a transistor 30a and a diode 30b connected in antiparallel to the transistor 30a. The other semiconductor elements UN, VP, VN, WP, and WN have the same configuration as the semiconductor element UP. The term “antiparallel” means that an anode side of the diode 30b is connected to a first terminal corresponding to a source of the MOSFET, while a cathode side of the diode 30b is connected to a second terminal corresponding to a drain of the MOSFET.

The semiconductor elements UP, UN, VP, VN, WP, and WN to be used may be, for example, insulated gate bipolar transistors (IGBTs) instead of the MOSFETs.

A connection point 32 between the upper-arm semiconductor element UP and the lower-arm semiconductor element UN of the leg 30A is connected to a first phase (for example, the u phase) of the rotating machine 2. A connection point 33 between the upper-arm semiconductor element VP and the lower-arm semiconductor element VN of the leg 30B is connected to a second phase (for example, the v phase) of the rotating machine 2. A connection point 34 between the upper-arm semiconductor element WP and the lower-arm semiconductor element WN of the leg 30C is connected to a third phase (for example, the w phase) of the rotating machine 2. The connection points 32, 33, and 34 of the voltage application unit 3 constitute alternating current terminals.

A description of voltage vectors that the voltage application unit 3 outputs is provided here. The voltage application unit 3 is, as mentioned earlier, the three-phase PWM inverter, serving as a power conversion unit that obtains desired voltage by performing PWM control on the direct-current power with voltage V_{DC} supplied from the power source 36 through the direct-current buses 35a and 35b. The three-phase PWM inverter has the two vertically arranged semiconductor switching elements for each phase, and the upper and lower semiconductor switching elements operate such that one of the semiconductor switching elements is in an ON state. Therefore, the three-phase PWM inverter has two cubed (eight) possible switching states.

Next, a description is provided of the aforementioned precomputed comparison values crₛₜ₁, crₛₜ₂, crₙₜ₁, crₙₜ₂, and θₜ, which are used in the timing generator 5 illustrated in FIG. 2.

When, for example, the asynchronous and synchronous carrier waves, assumed for switching between the PWM modes during operation of the rotating machine 2, are in the relationship illustrated in FIG. 15, the magnetic flux evaluation function E_{fas} illustrated in FIG. 16 is precomputed outside the rotating machine control device 1. This precomputation is done by integrating three-phase asynchronous PWM pulses, which are obtained from magnitude comparison between the modulation waves corresponding to the asynchronous PWM and the asynchronous carrier waves, and three-phase synchronous PWM pulses, which are obtained from magnitude comparison between the modulation waves corresponding to the synchronous PWM and the synchronous carrier waves, and then performing computations described in Formulas (6), (7), and (8) above.

As described first in the present embodiment, the phase at which the magnetic flux evaluation function E_{fas}, represented on a vertical axis in FIG. 16, reaches a minimum value is a phase that minimizes amplitudes of current oscillations. In FIG. 16, the u-phase voltage phase at 223 degrees is the phase that minimizes the amplitudes of the current oscillations. Therefore, by extracting and utilizing a sign of slope and an instantaneous value of each of the asynchronous and synchronous carrier waves at the 223-degree u-phase voltage phase from FIG. 15, the current oscillations can be restrained during switching between the PWM modes, even without the computation of the motor fluxes during the operation of the rotating machine 2. In other words, the signs of the slopes and the instantaneous values of the asynchronous and synchronous carrier waves, which correspond to when the magnetic flux evaluation function E_{fas} reaches its minimum and can be identified from the relationship between the asynchronous and synchronous carrier waves, are precomputed and used as the aforementioned comparison values crₛₜ₁, crₛₜ₂, crₙₜ₁, and crₙₜ₂. Furthermore, the u-phase voltage phase at which the magnetic flux evaluation function E_{fas} reaches its minimum is used as the aforementioned comparison value et. As described, the comparison values crₛₜ₁, crₛₜ₂, crₙₜ₁, crₙₜ₂, and θₜ needed when the timing generator 5 generates the timing signal Tr can be precomputed.

Since the three-phase PWM pulses are generated by comparing the modulation waves vᵤ⁺, vᵥ⁺, and v_{w}⁺ with the carrier waves crᵤ, crᵥ, and cr_{w}, their respective average values over one cycle may not equal 0, unlike with a sine wave. Integrating the three-phase PWM pulses with their respective average values over one cycle not equaling 0 causes the integrals to diverge positively or negatively, depending on signs of the three-phase PWM pulses' average values over one cycle. Accordingly, the integrals of the three-phase PWM pulses may be computed after the average value of the PWM pulses corresponding to each phase over one cycle is subtracted from the three-phase PWM pulses.

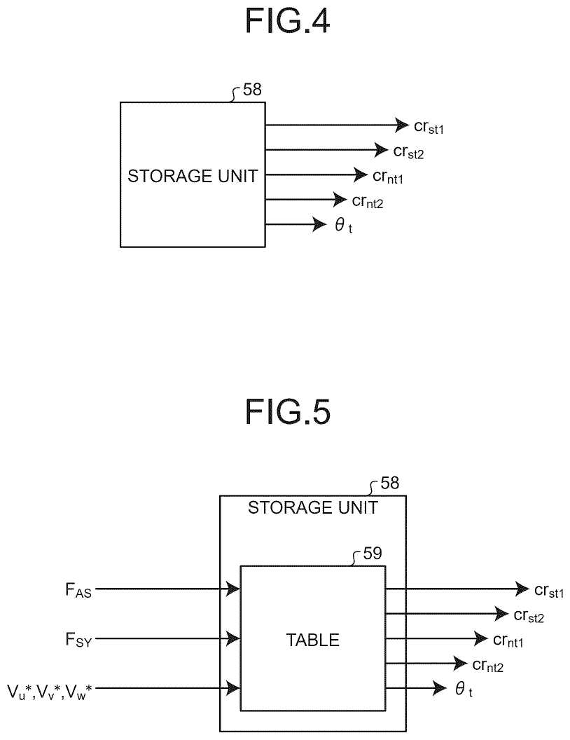

As illustrated in FIG. 4, the above comparison values crₛₜ₁, crₛₜ₂, crₙₜ₁, crₙₜ₂, and θₜ are stored in a storage unit 58 and are output from the storage unit 58 when the timing generator 5 generates the timing signal Tr. FIG. 4 is a diagram illustrating the storage unit 58 given as an example to store the comparison values that the timing generator 5 according to the first embodiment uses in a process of generating the timing signal Tr. The storage unit 58 may be provided inside or outside the timing generator 5.

The above comparison values crₛₜ₁, crₛₜ₂, crₙₜ₁, crₙₜ₂, and θₜ may be fixed values or may be variables stored in a table, being outputs that change depending on input conditions. FIG. 5 illustrates an exemplary configuration of a storage unit 58 where the comparison values crₛₜ₁, crₛₜ₂, crₙₜ₁, crₙₜ₂, and θₜ are the variables. FIG. 5 is a diagram illustrating the storage unit 58 given as another example to store the comparison values that the timing generator 5 according to the first embodiment uses in the process of generating the timing signal Tr. The storage unit 58 that is illustrated as the different example in FIG. 5 includes a table 59. In the table 59 illustrated in FIG. 5, an asynchronous carrier wave frequency F_{AS} within one cycle of the output voltage phase command θ, a synchronous carrier wave frequency F_{SY} within one cycle of the output voltage phase command θ, and the voltage commands Vᵤ⁺, Vᵥ⁺, and V_{w}⁺ are input, and a linear search is performed to output the precomputed and retained comparison values crₛₜ₁, crₛₜ₂, crₙₜ₁, crₙₜ₂, and θₜ.

As described above, the rotating machine control device 1 according to the present embodiment is configured to appropriately use one of the two PWM modes, namely the asynchronous PWM and the synchronous PWM, to control the rotating machine 2. The rotating machine control device 1 includes the timing generator 5 that detects the timing for switching to the PWM mode to be used, which restrains current oscillations, and generates the signal indicating this timing. The timing generator 5 detects the timing for the switching between the PWM modes on the basis of the first carrier wave used for the PWM pulse generation in the asynchronous PWM, the second carrier wave used for the PWM pulse generation in the synchronous PWM, and the output voltage phase command. The timing generator 5 then changes the timing signal being output to the state that indicates that the timing qualifies for switching between the PWM modes. Specifically, the timing generator 5 detects, on the basis of the first carrier wave crᵤ₁, the second carrier wave crᵤ₂, the output voltage phase command θ, and the precomputed comparison values crₛₜ₁, crₛₜ₂, crₙₜ₁, crₙₜ₂, and θₜ, the timing at which the relationship established between the first carrier wave crᵤ₁, crᵥ₁, or cr_{w1} and the second carrier wave crᵤ₂, crᵥ₂, or cr_{w2} causes a difference between the integral of the asynchronous PWM pulses and the integral of the synchronous PWM pulses to become less than a predetermined value. The timing generator 5 then changes the output state of the timing signal. The control unit 4 of the rotating machine control device 1 switches the PWM mode used for controlling the rotating machine 2 when the state of the timing signal output from the timing generator 5 changes. In this way, the PWM mode can be switched at the timing when the difference between the magnetic flux of the rotating machine 2 in the asynchronous PWM and the magnetic flux of the rotating machine 2 in the synchronous PWM becomes smaller, resulting in restrained current oscillations during the switching between the PWM modes.

### Second Embodiment

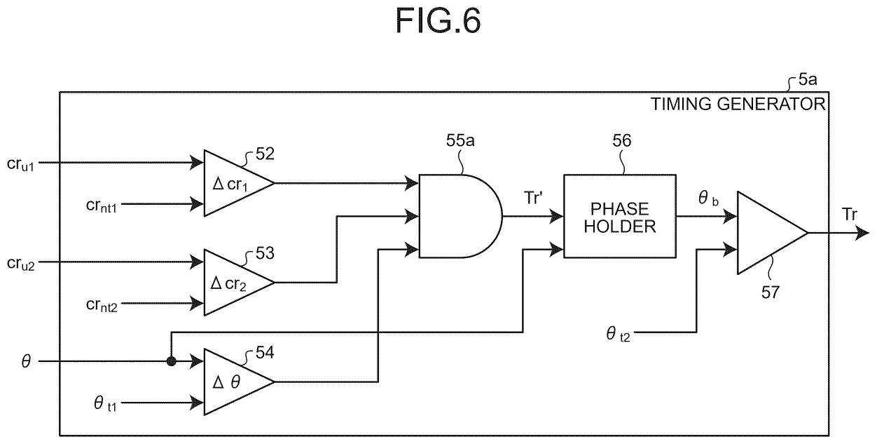

Next, a description of a second embodiment is provided. For convenience's sake, a rotating machine control device according to the second embodiment is referred to as the rotating machine control device 1a, to be distinguished from the rotating machine control device 1 according to the first embodiment. The rotating machine control device 1a according to the present embodiment includes a timing generator 5a illustrated in FIG. 6 in place of the timing generator 5 (refer to FIGS. 1 and 2) included in the rotating machine control device 1 according to the first embodiment. Constituent elements other than the timing generator 5a are the same as those in the first embodiment and thus are not described. FIG. 6 is a diagram illustrating an exemplary configuration of the timing generator 5a included in the rotating machine control device 1a according to the second embodiment.

The timing generator 5a includes the operators 52 to 54, a logical conjunction operator 55a, a phase holder 56, and an operator 57. The operators 52 to 54 are the same as the operators 52 to 54 of the timing generator 5 according to the first embodiment and thus are not described. In the present embodiment, θₜ₁ is input to the operator 54 as a result of computing the output voltage phase command θ.

Signals output respectively from the operators 52 to 54 are input to the logical conjunction operator 55a. The logical conjunction operator 55a outputs a value indicating true as a timing signal Tr′ when every input signal is a value indicating true, that is, “1” and a value indicating false as the timing signal Tr′ when the input signals include any values indicating false. Specifically, the logical conjunction operator 55a outputs “1” as the timing signal Tr′ when every input signal is the value indicating true and “0” as the timing signal Tr′ when the input signals include any values indicating false.

The timing signal Tr′ output from the logical conjunction operator 55a and the output voltage phase command θ are input to the phase holder 56. The phase holder 56 retains a phase of the output voltage phase command θ at a timing when the timing signal Tr′ changes from false to true and outputs the retained phase as a reference phase θ_{b}. This means that the phase holder 56 keeps outputting the value of the output voltage phase command θ that corresponds to the timing when the timing signal Tr′ has changed from false to true as the reference phase θ_{b}.

The reference phase θ_{b} output from the phase holder 56 and a precomputed delayed phase θₜ₂ retained in the memory are input to the operator 57. The operator 57 computes a phase difference between the input reference phase θ_{b} and the input delayed phase θₜ₂. The operator 57 outputs a value indicating true as the timing signal Tr when the computed phase difference is 0 or within an acceptable range of deviation and a value indicating false as the timing signal Tr when the computed phase difference is not within the acceptable range of deviation. Specifically, the operator 57 outputs “1” as the timing signal Tr when the computed phase difference is less than a predetermined threshold and “0” as the timing signal Tr when the computed phase difference is greater than or equal to the threshold.

The timing generator 5a according to the second embodiment, which is illustrated in FIG. 6, uses the specific phase at which the asynchronous and synchronous carrier waves each peak at −1 or +1 (a maximum or minimum value) as the reference phase θ_{b} and outputs the timing signal Tr at a phase delayed by a fixed amount relative to the reference phase θ_{b}.

The operators 52 and 53 respectively detect peaks of the carrier waves crᵤ₁ and crᵤ₂. Since each carrier wave has a slope of 0 at its peak, there is no need to determine a sign of the slope. Therefore, the precomputed comparison value crₙₜ₁ for the first carrier wave crᵤ₁ and the precomputed comparison value crₙₜ₂ for the second carrier wave crᵤ₂ are set to −1 or +1. The precomputed comparison value θₜ₁ for the output voltage phase command θ is set to a phase at which the synchronous carrier wave peaks. For example, in the example illustrated in FIG. 15 used above, since the asynchronous and synchronous carrier waves each reach −1 at 150 degrees, the reference phase θ_{b} can be set to 150 degrees.

A description is provided of the precomputed delayed phase θₜ₂. Consider that the first carrier wave crᵤ₁ and the second carrier wave crᵤ₂ that are input to the timing generator 5a are respectively the asynchronous and synchronous carrier waves illustrated in the example of FIG. 15. In this case, the asynchronous and synchronous carrier waves generate the magnetic flux evaluation function E_{fas} that is illustrated in FIG. 16. In FIG. 16, the phase at which the magnetic flux evaluation function E_{fas} reaches its minimum is 223 degrees. Therefore, when the reference phase θ_{b} is set to 150 degrees, the delayed phase θₜ₂ is set to 223 degrees. The timing generator 5a outputs the timing signal Tr based on this setting, and the PWM mode selector 6 switches the PWM mode at a timing in line with this timing signal Tr. Consequently, current oscillations during switching between the PWM modes are restrained.

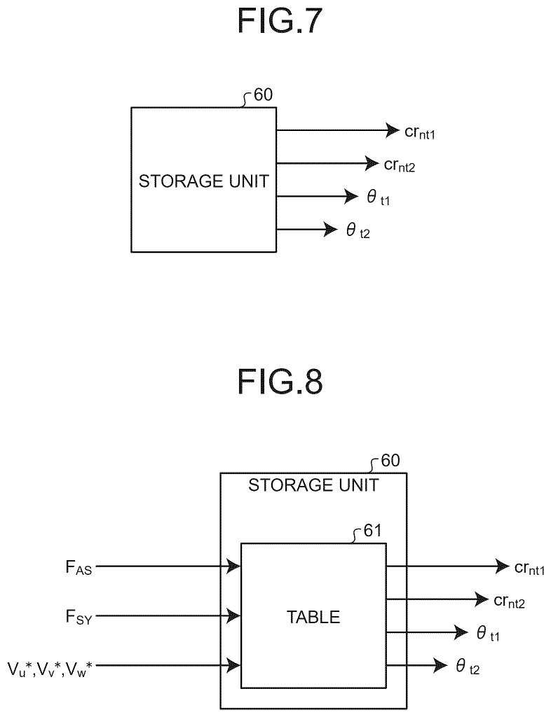

As illustrated in FIG. 7, the precomputed comparison values crₙₜ₁, crₙₜ₂, and θₜ₁ and the precomputed delayed phase θₜ₂ in FIG. 6 are stored in a storage unit 60 and are output from the storage unit 60 when the timing generator 5a generates the timing signal Tr. FIG. 7 is a diagram illustrating the storage unit 60 given as an example to store the comparison values and the delayed phase that the timing generator 5a according to the second embodiment uses in a process of generating the timing signal Tr. The storage unit 60 may be provided inside or outside the timing generator 5a.

The above comparison values crₙₜ₁, crₙₜ₂, and θₜ₁ and the delayed phase θₜ₂ may be fixed values or may be variables stored in a table, being outputs that change depending on input conditions. FIG. 8 illustrates an exemplary configuration of a storage unit 60 where the comparison values crₙₜ₁, crₙₜ₂, and θₜ₁ and the delayed phase θₜ₂ are the variables. FIG. 8 is a diagram illustrating the storage unit 60 given as another example to store the comparison values and the delayed phase that the timing generator 5a according to the second embodiment uses in the process of generating the timing signal Tr. The storage unit 60 that is illustrated as the different example in FIG. 8 includes a table 61. In the table 61 illustrated in FIG. 8, the asynchronous carrier wave frequency F_{AS} within one cycle of the output voltage phase command θ, the synchronous carrier wave frequency F_{SY} within one cycle of the output voltage phase command θ, and the voltage commands Vᵤ⁺, Vᵥ⁺, and V_{w}⁺ are inputs, and a linear search is performed to output the precomputed and retained comparison values crₙₜ₁, crₙₜ₂, and θₜ₁ and the precomputed and retained delayed phase θₜ₂.

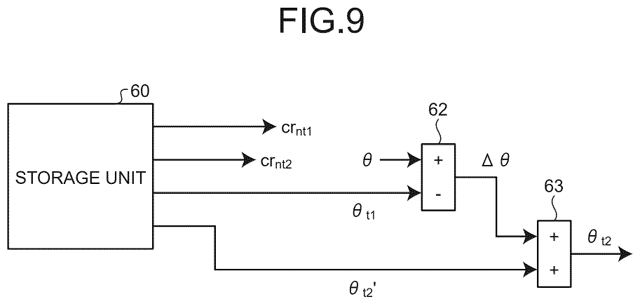

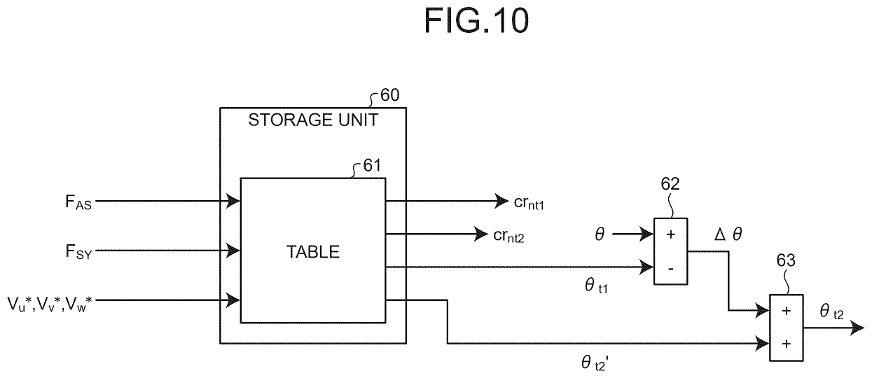

The storage unit 60 may be configured as illustrated in FIG. 9 or FIG. 10. FIG. 9 is a diagram illustrating a variation of the storage unit 60 illustrated in FIG. 7. FIG. 10 is a diagram illustrating a variation of the storage unit 60 illustrated in FIG. 8.

The configuration illustrated in each of FIGS. 9 and 10 differs in that information stored in the storage unit 60 partly differs from the information stored in the storage unit 60 illustrated in each of FIGS. 7 and 8 and that operators 62 and 63 are included downstream of the storage unit 60. While the storage unit 60 illustrated in each of FIGS. 7 and 8 stores, as mentioned above, the comparison values crₙₜ₁, crₙₜ₂, and θₜ₁ and the delayed phase θₜ₂, the storage unit 60 illustrated in each of FIGS. 9 and 10 stores the comparison values crₙₜ₁, crₙₜ₂, and θₜ₁ and the delayed phase θₜ₂′. In other words, the storage unit 60 illustrated in each of FIGS. 9 and 10 stores the delayed phase θₜ₂′ instead of the delayed phase θₜ₂, which is stored in the storage unit 60 illustrated in each of FIGS. 7 and 8.

In the configuration illustrated in each of FIGS. 9 and 10, the operator 62 computes a phase difference Δθ between the output voltage phase command θ and the comparison value θₜ₁ retained in the storage unit 60. Furthermore, the operator 63 adds the phase difference Δθ output from the operator 62 to the delayed phase θₜ₂′ retained in the storage unit 60 and outputs a result of this addition operation as a corrected delayed phase θₜ₂. When the phase difference Δθ is not 0, the reference phase θ_{b} will be misaligned with the peak of the synchronous carrier wave, so that the phase at which the magnetic flux evaluation function E_{fas} reaches the minimum value will also be misaligned. For this reason, the operator 63 adds the phase difference Δθ to the delayed phase θₜ₂′ to correct the delayed phase θₜ₂′, thus obtaining the corrected delayed phase θₜ₂.

The rotating machine control device 1a to which the timing generator 5a described in the present embodiment is applied can switch the PWM mode at the same timing as the rotating machine control device 1 according to the first embodiment and can restrain current oscillations during switching between the PWM modes.

The above configurations illustrated in the embodiments are illustrative, can be combined with other techniques that are publicly known, and can be partly omitted or changed without departing from the gist. The embodiments can be combined with each other.

### REFERENCE SIGNS LIST

1 rotating machine control device; 2 rotating machine; 3 voltage application unit; 4 control unit; 5, 5a timing generator; 6 PWM mode selector; 7 modulation wave generator; 8 carrier wave selector; 9 PWM pulse generator; 30A, 30B, 30C leg; 30a transistor; 30b diode; 32, 33, 34 connection point; 35a, 35b direct-current bus; 36 power source; 50 first determiner; 51 second determiner; 52, 53, 54, 57, 62, 63 operator; 55, 55a logical conjunction operator; 56 phase holder; 58, 60 storage unit; 59, 61 table.

1. A rotating machine control device comprising:
a voltage applicator to generate three-phase voltages to be applied to a rotating machine; and
a controller to control voltage generation operation of the voltage applicator in a first pulse-width modulation mode or a second pulse-width modulation mode, the first pulse-width modulation mode being a pulse-width modulation method where a carrier wave frequency is asynchronous with a frequency of a voltage command, the second pulse-width modulation mode being a pulse-width modulation method where a carrier wave frequency is synchronous with the frequency of the voltage command, wherein
on a basis of a first carrier wave used in generating a signal that controls the voltage applicator in the first pulse-width modulation mode, a second carrier wave used in generating a signal that controls the voltage applicator in the second pulse-width modulation mode, and an output voltage phase command commanding a phase of each of voltages to be output to the rotating machine, the controller selects one of the first pulse-width modulation mode and the second pulse-width modulation mode as a pulse-width modulation method to be used for controlling the voltage generation operation, wherein
when switching a pulse-width modulation method used for controlling the voltage generation operation, the controller detects, on the basis of the first carrier wave, the second carrier wave, and the output voltage phase command, a timing at which a difference between a flux linkage of the rotating machine during the control of the voltage generation operation in the first pulse-width modulation mode and a flux linkage of the rotating machine during the control of the voltage generation operation in the second pulse-width modulation mode is minimized and uses the detected timing as a timing for switching the pulse-width modulation method.

2. (canceled)

3. The rotating machine control device according to claim 1, wherein
the controller includes
a timing generator to determine a timing for switching a pulse-width modulation method used for controlling the voltage generation operation on the basis of the first carrier wave, the second carrier wave, and the output voltage phase command and
a pulse-width modulation mode selector to select the one of the first pulse-width modulation mode and the second pulse-width modulation mode as a pulse-width modulation method to be used for controlling the voltage generation operation when the timing generator determines that the timing qualifies for switching the pulse-width modulation method.

4. The rotating machine control device according to claim 3, comprising a storage circuitry to retain a sign of slope of the first carrier wave, a sign of slope of the second carrier wave, an instantaneous value of the first carrier wave, an instantaneous value of the second carrier wave, and a phase of a voltage to be output to the rotating machine that correspond to when a difference between a flux linkage of the rotating machine during the control of the voltage generation operation in the first pulse-width modulation mode and a flux linkage of the rotating machine during the control of the voltage generation operation in the second pulse-width modulation mode is minimized, wherein
the timing generator
determines that the timing qualifies for switching the pulse-width modulation method when a sign of slope of the first carrier wave and a sign of slope of the second carrier wave respectively match a sign of slope of the first carrier wave and a sign of slope of the second carrier wave that are retained in the storage circuitry, a difference between an instantaneous value of the first carrier wave and an instantaneous value of the first carrier wave that is retained in the storage circuitry and a difference between an instantaneous value of the second carrier wave and an instantaneous value of the second carrier wave that is retained in the storage circuitry are each less than a predetermined threshold, and a difference between a value of the output voltage phase command and a phase of a voltage to be output to the rotating machine that is retained in the storage circuitry is less than a predetermined threshold.

5. The rotating machine control device according to claim 4, wherein
the storage circuitry includes
a table where a frequency of the first carrier wave, a frequency of the second carrier wave, and the voltage command are input, and a linear search is performed to output a sign of slope of the first carrier wave, a sign of slope of the second carrier wave, an instantaneous value of the first carrier wave, an instantaneous value of the second carrier wave, and a phase of a voltage to be output to the rotating machine that are retained.

6. The rotating machine control device according to claim 3, comprising
a storage circuitry to retain an instantaneous value of the first carrier wave, an instantaneous value of the second carrier wave, and a phase of a voltage to be output to the rotating machine that correspond to when a difference between a flux linkage of the rotating machine during the control of the voltage generation operation in the first pulse-width modulation mode and a flux linkage of the rotating machine during the control of the voltage generation operation in the second pulse-width modulation mode is minimized, and a delayed phase derived from a relationship between the first carrier wave and the second carrier wave, wherein
at a moment when a difference between an instantaneous value of the first carrier wave and an instantaneous value of the first carrier wave that is retained in the storage circuit and a difference between an instantaneous value of the second carrier wave and an instantaneous value of the second carrier wave that is retained in the storage circuitry are each less than a predetermined threshold and a difference between a value of the output voltage phase command and a phase of a voltage to be output to the rotating machine that is retained in the storage circuitry is less than a predetermined threshold, the timing generator uses a value of the output voltage phase command as a reference phase, and the timing generator determines that the timing qualifies for switching the pulse-width modulation method when a difference between the reference phase and the delayed phase retained in the storage circuity is less than a predetermined threshold.

7. The rotating machine control device according to claim 6, wherein
the storage circuitry includes
a table where a frequency of the first carrier wave, a frequency of the second carrier wave, and the voltage command are input, and a linear search is performed to output the instantaneous value of the first carrier wave, the instantaneous value of the second carrier wave, a phase of a voltage to be output to the rotating machine, and the delayed phase that are retained.

8. The rotating machine control device according to claim 6, wherein
a phase difference between a value of the output voltage phase command and a phase of a voltage to be output to the rotating machine that is output from the storage circuitry is computed, the phase difference computed is added to the delayed phase output from the storage circuitry to correct the delayed phase, and the timing generator determines the timing for switching, using the delayed phase corrected.

9. The rotating machine control device according to claim 7, wherein
a phase difference between a value of the output voltage phase command and a phase of a voltage to be output to the rotating machine that is output from the storage circuitry is computed, the phase difference computed is added to the delayed phase output from the storage circuitry to correct the delayed phase, and the timing generator determines the timing for switching, using the delayed phase corrected.
